(19) United States
(12) Patent Application Publication
(10) Pub. No.: US 2004/0169872 A1
(43) Pub. Date: Sep. 2, 2004

(54) Blind inverse halftoning

(76) Inventor: Ron P. Maurer, Haifa (IL)

Correspondence Address: HEWLETT-PACKARD COMPANY, Intellectual Property Administration, P.O. Box 272400, Fort Collins, CO, 80527-2400, US

(21) Appl. No.: 10/376,911

(22) Filed: Feb. 28, 2003

(51) Int. Cl. G06T 5/00; H04N 1/409

(52) U.S. Cl. 358/1.9; 380/260; 382/264; 358/3.08; 358/3.26

(57) ABSTRACT

Blind inverse halftoning on a digital image is performed by applying a robust convolution filter to the digital image.

### BACKGROUND

Halftoning techniques are frequently used to render continuous-tone (grayscale or color) images for reproduction on output devices with a limited number of tone levels. Patterns of closely spaced tiny dots of the appropriate color are printed on paper or displayed on a monitor such as a CRT (cathode-ray tube), or LCD (liquid crystal display).

In certain applications, halftone images are first printed to an output medium (paper or monitor), and than captured with a digital device such as an image scanner, which yields an approximated continuous tone image. The recaptured image is essentially considered as a “contone” image, which is contaminated with halftoning noise, rather than a halftone image distorted by printing and scanning degradations.

Inverse halftoning refers to the process of selectively removing halftoning noise, and approximately recovering a contone image from its halftoned version. Inverse halftoning methods can be classified according to their use of “prior knowledge”. Certain inverse halftoning methods require knowledge on the halftoning method, and/or the scanning device which captured the printed image. Other inverse halftoning methods are “blind” in that they do not require such knowledge. Typically, blind methods use some assumptions on the image characteristics (e.g. existence of edges in the image).

### SUMMARY

According to one aspect of the present invention, blind inverse halftoning on a digital image is performed by applying a robust convolution filter to the digital image. Other aspects and advantages of the present invention will become apparent from the following detailed description, taken in conjunction with the accompanying drawings, illustrating by way of example the principles of the present invention.

### BRIEF DESCRIPTION OF THE DRAWINGS

FIG. 1 is an illustration of a 3×3 pixel neighborhood, with indications of discrete angles where coherence measures are computed and averaged.

FIGS. 2 and 3 are illustrations of method of performing blind inverse halftoning in accordance with embodiments of the present invention.

FIG. 4 is an illustration of a digital imaging system including a machine for performing the method of FIG. 1.

### DETAILED DESCRIPTION

Inverse halftoning on a grayscale image is performed by applying a robust convolution filter to the grayscale image. The robust convolution filter may have the general form:

$${F}_{n} = {I}_{n} + α \cdot {\sum }_{k} {C}_{k} \cdot {ψ}_{k} ( {I}_{n - k} - {I}_{n} )$$

where indices n,k are each a compound vector index with two components (e.g. n={nₓ,n_{y}}), Iₙ is the grayscale value of the n^{th} pixel in the grayscale image,

$$CORR = α \cdot {\sum }_{k} {C}_{k} \cdot {ψ}_{k} ( {I}_{n - k} - {I}_{n} ) ,$$

which is a correction term for grayscale value of the n^{th} pixel, Cₖ is a coefficient of a filter mask,

$${\sum }_{k} {C}_{k} = 1 ,$$

(Iᵢ₋ₖIₙ) is the difference in grayscale values between the n^{th} pixel and its k^{th} neighbor (the k^{th} central difference), ψ is a robust influence function, α is a correction scaling factor, and Fₙ is a filtered value of the n^{th} pixel.

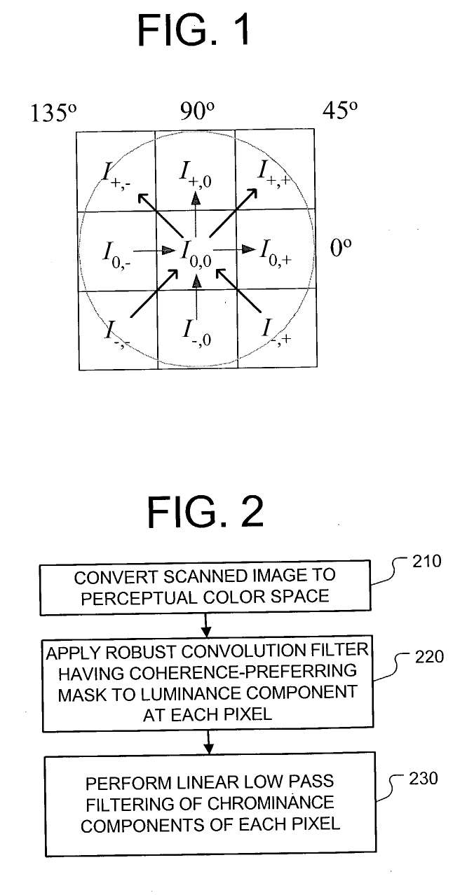

The robust convolution filter uses a moving window. FIG. 1 shows an exemplary 3×3 window. The pixel being processed (I_{0,0}), also referred to as the “pixel of interest” and also the “center pixel,” is at the center of the window. The window encompasses eight neighbors of the central pixel.

The coefficients of the filter mask are used for taking a weighted average of the pixel of interest and its neighbors. The filter mask may correspond to a mask used for linear low pass filtering. For example, the following classical (binomial) mask may be used.

$${C}^{[ b ]} = \frac{1}{16} [ \begin{matrix}1 & 2 & 1 \\ 2 & 4 & 2 \\ 1 & 2 & 1\end{matrix} ]$$

The robust influence function reduces large photometric (grayscale) differences between the center pixel and its neighbors. If the center pixel is bright, and most of its neighbors are bright, but a few neighbors are dark, then the robust influence function reduces the influence of those few dark pixels. Thus the robust influence function limits the influence of neighboring pixels that are very different.

In a window containing an edge, a first group of pixels will be bright, and another group will be dark. If the center pixel is part of the bright group, the filtered value will not be greatly affected by the dark pixels. Similarly, if the center pixel is part of the dark group, then the neighboring bright pixels will not greatly affect the value of the center pixel. As a result of the robust influence function, the amount of blurring of edges is reduced.

The robust influence function may have the form

$${ψ}_{T} ( Δ I ) = \{ \begin{matrix}Δ I \geq T & T \\ \vert Δ I \vert < T & Δ I \\ Δ I \leq - T & - T\end{matrix}$$

where ΔI represents a grayscale difference between any two neighboring pixels, and T is an influence limiting threshold.

The influence limiting threshold T can be different for different neighbors. For example, the threshold Tₖ can differ according to the Euclidean distance of the kₜₕ neighbor from the center pixel. Thus a different threshold Tₖ may be used for each neighbor.

A uniform value may be used for each Tₖ throughout the digital image. The value corresponds to the expected or estimated halftone noise amplitude.

In the alternative, the threshold Tₖ can vary spatially. A higher threshold is used for a halftone region, since halftone noise typically has a much higher amplitude than other types of noise (e.g., noise injected by scanner electronics). The decision to use a higher threshold for halftone noise, or a lower threshold for other types of noise, may be made according to the likelihood that the region contains a halftone pattern.

The influence limiting threshold(s) may be chosen according to the expected noise amplitude. That is, the thresholds may be based on estimates of halftone noise. The estimates may be based on system properties. In the alternative, the influence limiting thresholds may be determined experimentally by filtering scanned images with different thresholds, and selecting the best thresholds.

The correction scaling factor a can increase or decrease the effect of the correction term. Sharpening is performed for α<0, and smoothing is performed for α>0. The scale factor α can be uniform throughout the image, or it can be modified according to the local neighborhood. As but one example, lower positive values of α can be used in low variance regions, while higher values of α can be used at edges.

A robust convolution filter including a low pass filter mask is very good at smoothing low variance regions that originally corresponded to uniform colors. However, such a filter tends to have two shortcomings: (1) the robust influence function does not fully reduce blurring at edges, and (2) the filter tends to undersmooth parallel to edges. Relatively large differences between pixels on the same side of a salient edge are left. As a result, the lighter side of an edge has a few isolated dark pixels. This noise, which is usually perceptible, tends to degrade image quality and reduce compressibility of the inverse halftoned image.

These two shortcomings can be overcome by using a “coherence-preferring” mask instead of the low pass filter mask. A robust convolution filter with a coherence-preferring mask preserves edges and better smoothes pixels that are parallel to edges. The coherence-preferring mask is based on a maximization of a local coherence measure. A filter using this mask produces a pixel value that maximizes coherence in a local neighborhood, without determining edge orientation.

Derivation of the coherence-preferring mask will be explained in connection with a three-tap one-dimensional signal, and then the derivation will be extended to a 2-D mask. For simplicity, the derivation is performed without considering robustness.

Spatial coherence measure for a three-tap one-dimensional signal [I₋I₀I₋] is maximal when the three values have a linear relation, i.e. when I₊−I₀=I₀−I₋. Coherence is negative when the signs of these two differences oppose (as in a triangle shape). The simplest measure would be just the product of these two differences, i.e. (I₊−I₀)×(I₀−I₋). However, this measure yields zero coherence for “abrupt” edges, where one of these differences is equal to zero. Therefore, the middle value I₀ is replaced by a weighted average (low-pass filter) of the three values. The edge-coherence measure (φ) becomes

φ=(I₊−\overline{I})(\overline{I}−I₋)

where a>0 and

$$\begin{matrix}\overline{I} ≡ {I}_{0} + a \cdot ( \frac{{I}_{-} + {I}_{+}}{2} - {I}_{0} ) = ( \frac{1}{2} a ) {I}_{-} + ( 1 - a ) {I}_{0} + ( \frac{1}{2} a ) {I}_{+} \\ = [ \begin{matrix}\frac{1}{2} a & 1 - a & \frac{1}{2} a ] * [ \begin{matrix}{I}_{-} & {I}_{0} & {I}_{+} ] .\end{matrix}\end{matrix}\end{matrix}$$

If a=½, the mask

$$[ \frac{1}{2} a \qquad 1 - a \qquad \frac{1}{2} a ]$$

becomes a binomial mask.

Referring to FIG. 1, the coherence measure can be extended to a two-dimensional 3×3 window by taking a weighted average of one-dimensional coherence measures covering all discrete angles within a 180 degree range: 0 degrees, 45 degrees, 90 degrees, and 135 degrees. The discrete angles are illustrated in FIG. 1. The relative weights are determined by geometry to have approximately isotropic response of the coherence measure with respect to edge-orientation. The two-dimensional coherence measure may be as

φ_{2D}=β[(I_{+,0}−\overline{I})(\overline{I}−I_{-,0})+(I_{0,+}−\overline{I})(\overline{I}−I_{0,-})]+γ[(I_{+,-}−\overline{I})(\overline{I}−I_{-,+})+(I_{+,+}−\overline{I})(\overline{I}−I_{-,-)]}

where β+γ=1. By geometrical considerations a preferred ratio is β/γ=4 (that is, β=4/5; γ=1/5). The weighted average intensity \overline{I} may be defined as

\overline{I}−aI_{0,0}+b(_{+,0}+I_{0,+}+I_{-,0}+I_{0,-})+c(_{+,-}+I_{+,+}+I_{-,+}+I_{-,-}) where

a+4b+4c=1. Preferred values for a, b and c are

$$a = \frac{1}{4} ; b = \frac{1}{8} ; and c = \frac{1}{16} .$$

The coherence measure may be maximized with respect to grayscale value of the center pixel by taking a derivative of the measure with respect to that value, and setting the derivative to zero.

$$\frac{ⅆ {φ}_{2 D}}{ⅆ {I}_{0 , 0}} = \frac{ⅆ {φ}_{2 D}}{ⅆ \overline{I}} \cdot \frac{ⅆ \overline{I}}{ⅆ {I}_{0 , 0}} = \frac{1}{4} \cdot \frac{ⅆ {φ}_{2 D}}{ⅆ \overline{I}} = 0 -> \frac{ⅆ {φ}_{2 D}}{ⅆ \overline{I}} = 0$$

The maximization of φ_{2D} with respect to \overline{I} yields

$$\overline{I} = \frac{β}{4} ( {I}_{+ , 0} + {I}_{0 , +} + {I}_{- , 0} + {I}_{0 , -} ) + \frac{γ}{4} ( {I}_{+ , -} + {I}_{+ , +} + {I}_{- , +} + {I}_{- , -} )$$

A value for the center pixel (I_{0,0}) can be derived from this maximization of φ_{2D} with respect to \overline{I} as

I_{0,0}=b′(_{+,0}+I_{-,0}+I_{-,0}+I_{0,-}+I_{0,+})+c′(I_{+,+}+I_{-,-}+I_{+,-}+I_{-,+}), where

$${b}^{′} = \frac{\frac{1}{4} β - b}{a} ; \frac{{c}^{′} = \frac{1}{4} γ - c}{a} ;$$

and (4b′+4c′=1).

The value for the center pixel (I_{0,0}) can be expressed in terms of a linear convolution filter with a 3×3 mask C^{[e]}, which operates on a 3×3 neighborhood: I_{0,0} =C^{[e]}*I (the symbol “*” denotes linear convolution). The mask C^{[e]} may be written as

$${C}^{[ e ]} = [ \begin{matrix}{c}^{′} & {b}^{′} & {c}^{′} \\ {b}^{′} & 0 & {b}^{′} \\ {c}^{′} & {b}^{′} & {c}^{′}\end{matrix} ] .$$

A mask C^{[e]} based on the preferred values

$$( a = \frac{1}{4} ; b = \frac{1}{8} ; c = \frac{1}{16} )$$

may be written as

$${C}_{1}^{[ e ]} = \frac{1}{20} [ \begin{matrix}- 1 & 6 & - 1 \\ 6 & 0 & 6 \\ - 1 & 6 & - 1\end{matrix} ]$$

This preferred mask C₁^{[e]} is but one example of a coherence-preferring mask. The coefficient values that are actually used will depend upon the definition of the weighted average of intensity (\overline{I}). For example, an alternative mask C₂^{[e]} can be obtained from the following values for a, b and c:

$$a = \frac{20}{80} , b = \frac{11}{80} , and c = \frac{4}{80} .$$

The alternative mask C₂^{[e]} may be written as

$${C}_{2}^{( e )} = \frac{1}{4} [ \begin{matrix}0 & 1 & 0 \\ 1 & 0 & 1 \\ 0 & 1 & 0\end{matrix} ] .$$

The preferred mask C₁^{[e]} does better on edges having angles of 0 degrees and 90 degrees. However, the alternative mask C₂^{[e]} is simpler and faster to compute.

The window can be larger than a 3×3. However, a 3×3 window is large enough to capture those isolated dark pixels on the light side of an edge. Moreover, a 3×3 window is far less complex to compute than a larger window. The 3×3 window can be applied iteratively to achieve the same effect as a larger window applied once

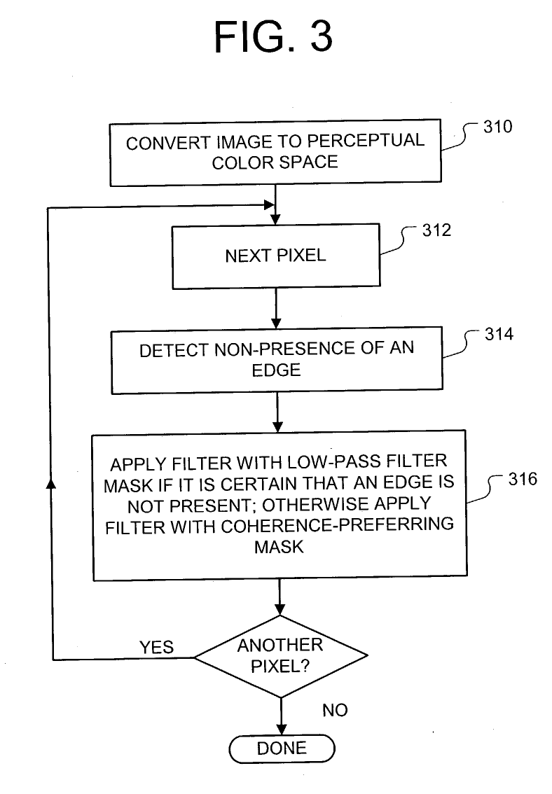

Reference is made to FIG. 2, which illustrates a first method of performing inverse halftoning on a scanned color image. The image is converted from RGB color space to a perceptual color space such as YC_{b}Cᵣ (210), and a robust convolution filter having a coherence-preferring mask is applied to the luminance component of each pixel in the scanned image (212). The chrominance components are processed in a simpler manner, since the human visual system is less sensitive to abrupt changes in chrominance than abrupt changes in luminance. A linear low pass filter performs adequate filtering of the chrominance components.

Reference is now made to FIG. 3, which illustrates an alternative method of using two robust convolution filters to perform inverse halftoning on a scanned color image. The first filter has a coherence-preferring mask, and the second filter has a low-pass filter mask. The second filter is better at reducing noise in regions having low variance contrast, and the first filter is better at preserving edges and smoothing pixels parallel to edges.

The image is converted from RGB color space to a perceptual color space such as YCbCr (310). For each pixel (312), presence of an edge is detected (314). If it is certain that an edge is not present, the second (low-pass) filter is applied to the pixel of interest (316). If it is at least uncertain, the first filter is applied to the pixel of interest (316). In this respect, edge detection is biased towards the “edge” class (i.e. the edge detector may misclassify non-edge pixels as “edge” although they really are part of a halftone pattern, but only scarcely misclassify true edge pixels as “non edge”).

Edge detection on a pixel of interest may be performed by testing the central differences of the full neighborhood. The pixel of interest is considered a non-edge pixel if the absolute value of each of its central differences is less than a corresponding influence limiting threshold. That is |ΔI_{K}|<T_{K}, for each value of K.

As an alternative, only part of the neighborhood may be tested. For example, only the central differences of the four diagonal neighbors may be tested. If the absolute value of the central difference of any one of those neighbors exceeds a corresponding influence limiting threshold, then the robust convolution filter with the coherence-preferring mask is applied to the pixel of interest.

As yet another alternative, the central differences with the non-diagonal neighbors may be tested. In general, a non-edge pixel may be detected by testing the central differences of a symmetrical group of neighbors that are considered during edge detection.

This edge detection operation is integrated with the filtering operation, so that it incurs very little overhead above the actual filter computation. The results of the detection will indicate whether b′ and c′ are used, or whether b and c are used. Regardless of the mask that is used, the central differences of the neighbors are computed, the influence limiting thresholds are computed, and the robust influence function is applied to the central differences. These differences can then be tested, and the test results can be used to generate the selected mask.

Detection of low contrast regions may be performed as follows. The following change in notation is made with respect to FIG. 1. The diagonal elements I₁, I₃, I₇ and I₉ refer to pixels I_{+,-}, I_{+,+}, I_{-,-} and I_{-,+}. The non-diagonal elements I₂, I₄, I₆ and I₈ refer to pixels I_{+,0}, I_{0,-}, I_{0,+} and I_{-,0}. The contributions of the diagonal elements (Δ_{d}) and non-diagonal elements (Δ₊) may be computed as follows:

$$\begin{matrix}{Δ }_{d} = {\sum }_{j = 1 , 3 , 7 , 9} {ψ}_{Td} ( {T}_{d} , {I}_{j} - {I}_{0 , 0} ) , and \\ {Δ}_{+} = {\sum }_{j = 2 , 4 , 6 , 8} {ψ}_{T +} ( {σ}_{+} , {I}_{j} - {I}_{0 , 0} )\end{matrix}$$

where Td is corresponds to an influence limiting threshold for the diagonal elements, and T+ corresponds to an influence limiting threshold for the non-diagonal elements. If the center pixel is a non-edge pixel, its intensity is computed as I_{0,0}*=I_{0,0}+(bΔ₊+cΔ_{d}); otherwise, its intensity is computed as I_{0,0}*=I_{0,0}+(b′Δ₊+c′Δ_{d})

Instead of toggling between the coherence-preferring and low-pass masks, a weighted average of the two masks may be taken. Since the masks have the same symmetry and are defined by three parameters each: (a,b,c) versus (a′=0,b′,c′) the weighted average is taken only between three pairs of numbers according to the degree of confidence in the presence of an edge.

The coherence-preferring mask has a zero entry at the center, i.e. does not consider at all the original pixel value, and can be generalized to be some weighted average between the mask C^{[e]} and the identity mask, i.e. a weighted average between the original I_{0,0} and the I_{0,0} which corresponds to the neighbors. One way to form such an adaptive weighted average is to keep I_{0,0} from changing too much relative to its original value by limiting the correction term not to exceed some threshold T₀:

$${F}_{n} = {I}_{n} + {ψ}_{T0} ( {CORR}_{n} ) where {CORR}_{n} = α \cdot {\sum }_{k} {C}_{k} \cdot {ψ}_{k} ( {I}_{n - k} - {I}_{n} ) .$$

Here ψ_{T0}( ) is a robust influence function which limits the modification of the output, rather the influence of an input neighbor.

The robust convolution filter in general, and the filter having the coherence-preferring mask in particular, can reduce halftone noise, smooth pixels parallel to edges, and preserve edges in digital images, all without explicitly determining the orientation of the edges. The present invention can improve the performance of other image processing operations. As a benefit, the robust convolution filter can improve the quality of the digital image prior to post-processing operations (e.g., image compression based on foreground-background segmentation, bleed-through reduction, global tone mapping for background removal).

The robust convolution filter may be combined with any selective sharpening filter that resharpens edges that were partly blurred by the robust convolution filter, and that does not re-enhance halftoning noise.

For images with higher halftone noise content (e.g. high-resolution scans) stronger filtering may be needed. The low-computational complexity makes it viable to apply the robust convolution filter 2-3 times in succession, for stronger filtering while still preserving edges

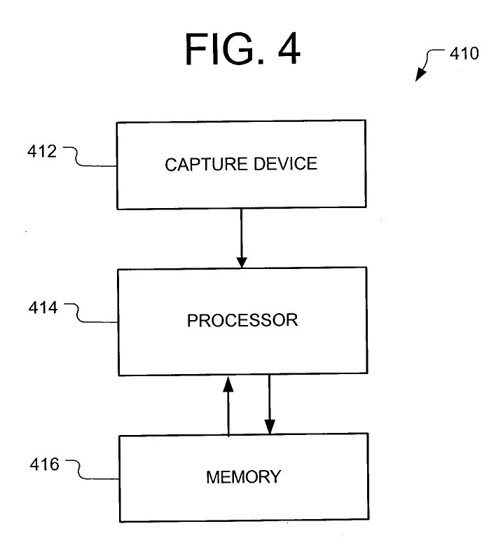

FIG. 4 shows a digital imaging system 410. An image capture device 412 scans a document and provides lines of a digital image to a processor 414. The processor 414 may store all of the lines of the digital image in memory 416 for processing later, or it may process the scanned image in real time. The output image may be stored in the memory 416. The processor 414 may use hardware, software or a combination of the two to process the digital image according to the methods above. The processor may perform additional processing as well.

In a software implementation, the memory 416 stores a program that, when executed, instructs the processor 414 to perform a method above. The processor 414 and memory 416 may be part of a personal computer or workstation, they may be embedded in an image capture device 412, etc.

In a hardware or software implementation, the processing can be performed using only integer arithmetic and precomputed lookup table terms. Thus the inverse halftoning can be implemented in a very efficient manner in real time.

The present invention is not limited to the specific embodiments described and illustrated above. Instead, the invention is construed according to the claims that follow.

1. A method of performing blind inverse halftoning on a digital image, the method comprising applying a robust convolution filter to the digital image.

2. The method of claim 1, wherein the filter includes a mask based on a linear low-pass filter.

3. The method of claim 1, wherein the filter includes a coherence-preferring mask.

4. The method of claim 3, wherein the coherence-preferring mask has the form
$${C}^{[ e ]} = [ \begin{matrix}{c}^{′} & {b}^{′} & {c}^{′} \\ {b}^{′} & 0 & {b}^{′} \\ {c}^{′} & {b}^{′} & {c}^{′}\end{matrix} ] ,$$
where 4b′+4c′+a′=1.

5. The method of claim 3, wherein the coherence-preferring mask has the values
$${C}^{[ e ]} = \frac{1}{20} [ \begin{matrix}- 1 & 6 & - 1 \\ 6 & 0 & 6 \\ - 1 & 6 & - 1\end{matrix} ] .$$

6. The method of claim 3, wherein the coherence-preferring mask has the values
$${C}^{( e )} = \frac{1}{4} [ \begin{matrix}0 & 1 & 0 \\ 1 & 0 & 1 \\ 0 & 1 & 0\end{matrix} ] .$$

7. The method of claim 3, wherein the filter avoids blurring edges and smoothes parallel to edges without determining edge orientation.

8. The method of claim 3, wherein the mask is based on a maximization of a measure of local spatial coherence.

9. The method of claim 8, wherein the local spatial coherence for a 3×3 window is a weighted average of one-dimensional edge coherence measurements at 0 degrees and multiples of 45 degrees.

10. The method of claim 9, wherein each one-dimensional coherence measurement is proportional to the product of off-center neighbors and modified central pixels, where each modified central pixel is a convolutions with a low pass filter mask.

11. The method of claim 1, wherein the filter uses a 3×3 pixel neighborhood.

12. The method of claim 1, wherein the digital image is a scanned image.

13. The method of claim 1, wherein the robust convolution filter includes a robust influence function having a plurality of influence limiting thresholds; wherein the influence limiting thresholds are different for different neighbors.

14. The method of claim 1, wherein the robust convolution filter includes the sum of a pixel intensity value and a correction term; and wherein the correction term includes a correction scale factor that is dependent on a local neighborhood.

15. The method of claim 1, wherein the filter includes a low-pass filter mask and is applied to non-edge pixels; and wherein the method further comprises applying a robust convolution filter having a coherence-preferring mask to remaining pixels of the digital image.

16. The method of claim 11, wherein a non-edge pixel is detected by testing the central differences of a symmetrical group of neighbors.

17. The method of claim 1, wherein the filter includes a mask that is a weighted average of low pass filter and coherent-preferring masks.

18. The method of claim 1, wherein the filter includes a mask that is a weighted average of a coherent-preferring mask and an identity mask.

19. Apparatus for performing blind inverse halftoning of a digital image, the apparatus comprising a robust convolution filter for filtering the digital image.

20. A system comprising:
a capture device for generating a digital image; and
a processor for performing inverse halftoning by applying a robust convolution filter to at least some pixels belonging to edges.

21. An article for a processor, the article comprising computer memory encoded with a robust convolution filter having a coherence-preferring mask.
